(19) United States
(12) Patent Application Publication
(10) Pub. No.: US 2008/0186306 A1
(43) Pub. Date: Aug. 7, 2008

(54) PROCEDURE FOR RENDERING IMAGES IN REAL TIME OF THREE-DIMENSIONAL MODELS OF ITEMS OF JEWELRY

(75) Inventors: CHRISTOPHE DARPHIN, TASSIN LA DEMI-LUNE (FR); LAURENT DIAZ, BLAUVAC (FR); CHRISTOPHE DUPUIS, GREZIEU LA VARENNE (FR)

Correspondence Address: CANTOR COLBURN, LLP, 20 Church Street, 22nd Floor, Hartford, CT, 06103, US

(73) Assignee: VISION NUMERIC, BRUSSIEU (FR)

(21) Appl. No.: 12/024,577

(22) Filed: Feb. 1, 2008

(30) Foreign Application Priority Data
Feb. 1, 2007 (FR) 07/00709

(51) Int. Cl. G06T 15/00

(52) U.S. Cl. 345/419; 345/441

(57) ABSTRACT

Procedure for rendering images in real time of three-dimensional models of items of jewellery Procedure for rendering images in real time of three-dimensional models of items of jewellery comprising at least one transparent or translucent stone having facets, which procedure comprises the steps consisting in determining a reference point in the stone, calculating the components of the normals to the facets of the stone in a discrete set of directions around the reference point and storing these components in a map of the normals, and simulating light reflections within the stone by calculating an approximation of the point of intersection between a ray and the stone using a simplified geometric shape of the stone and using, to calculate the direction of the reflected ray, a normal extracted from the map of the normals, corresponding to the point of the surface of the stone located in the direction of the point relative to the reference point.

### BACKGROUND OF THE INVENTION

The present invention relates to a procedure for rendering images in real time of three-dimensional models of items of jewellery comprising at least one transparent or translucent stone having facets.

### DESCRIPTION OF THE PRIOR ART

To render images of a three-dimensional model for simulating multiple reflections, it is known to use what is called the ray-tracing technique. This technique makes it possible to calculate in a precise manner the intersection of a ray on the surfaces of the model and the direction of the reflected and refracted rays. Multiple reflections within the object are taken into account.

This technique is satisfactory as regards the quality of the image rendition. However, the calculations performed are complex and are not optimal for rendition in real time.

For rendition applications in real time, it is necessary to simplify the calculations carried out. For this purpose, it is known to eliminate the effects of refraction and multiple reflections in the case of transparent or translucent objects, by applying a simple transparency to these objects, a ray thus passing through them as a straight line, with application of a transparency coefficient in order to calculate the color of a pixel as a weighted average of the color of the front face of the transparent object, of its rear face and of an opaque object located behind it.

It is also known, as in document WO 00/49573, to simulate simple refraction through a surface by the use of a texture that is shifted by a calculated distance according to refraction parameters.

However, the various techniques mentioned above do not make it possible to produce a real-time rendition that is realistic in the case of three-dimensional models of items of jewellery comprising at least one transparent or translucent stone having facets.

The technical problem at the basis of the invention is therefore how to provide a procedure for rendering images in real time of three-dimensional models of items of jewellery comprising at least one transparent or translucent stone having facets, in which the effect of the multiple internal reflections in a stone is taken into account by means of calculations compatible with the time constraints of real-time rendition.

### SUMMARY OF THE INVENTION

For this purpose, the subject of the present invention is a procedure for rendering images in real time of three-dimensional models of items of jewellery comprising at least one transparent or translucent stone having facets, which procedure comprises the steps consisting in:
determining a reference point in the stone;
calculating the components of the normals to the facets of the stone in a discrete set of directions around the reference point and storing these components in a map of the normals; and
simulating light reflections within the stone:
   by calculating an approximation of the point of intersection between a ray and the stone using a simplified geometric shape of the stone and
   using, to calculate the direction of the reflected ray, a normal extracted from the map of the normals, corresponding to the point of the surface of the stone located in the direction of the point relative to the reference point.

The simple geometric shape allows the points of intersection with the ray to be rapidly calculated. The normal of the stone is used to calculate the direction of the reflected ray using the Snell-Descartes law.

These arrangements make it possible to provide a realistic rendition in real time, for example when the user causes the item of jewellery to undergo a relative movement with respect to the virtual observation position.

This is because the combination of the simplified geometry and of the use of a map of normals, which is deduced from the actual geometry, combines the simplicity of the calculation with the reconstruction of the multiple reflections between facets giving the whole assembly depth.

This calculation is more particularly well suited for quasi-convex shapes and characteristic dimensions being of the same order of magnitude.

The results are of quality comparable to those that could be obtained with the conventional non-real-time ray-tracing procedure. The approximations made do not result in perceptible visual artifacts.

Preferably, the first intersection of a ray incident on the stone is calculated using the actual geometry.

According to one option, the simplified geometric shape is a sphere.

According to another option, the simplified geometric shape comprises two cones opposed by the base. Preferably, according to this other option, the simplified geometric shape is bounded by the intersection of the two cones and of a half-space bounded by a plane coinciding with the upper face of a stone.

Preferably, the map of the normals is stored in the form of an image, the color information about a given pixel corresponding to the coordinates of the normal at a given point of a facet of the stone in a given direction.

According to these arrangements, the stone seen from inside is as “folded”, to be displayed on an image. Graphics processors are suitable for storing and manipulating the stored data in image or texture form.

Advantageously, the relative calculations at the intersections of a ray and the stone using a simplified geometric shape are carried out on a graphics processor.

The graphics processor is responsible for converting geometric data into pixels that can be displayed on the screen. It constructs, from a set of triangles forming an object, a 2D representation that can be viewed on computer monitors. It associates a color with each pixel on the basis of information about the materials, the lighting model and the geometry.

Such arrangements exploit the possibilities provided by these programmable graphics pipelines in a language allowing the operations carried out by the processor of the graphics map to be controlled directly. Thus, a calculation is adapted in parallel with the calculation on a graphics map.

Preferably, the reference point (Pᵣ) is calculated as the intersection of planes of symmetry of the stone, of axes of symmetry of the stone, or as the center of the largest cross section of the stone.

Advantageously, a maximum number of reflections to be taken into account are used in the calculation steps.

Preferably, different refractive indexes are taken into account for different wavelengths.

These arrangements make it possible to reconstruct iridescence effects.

Advantageously, the approximation of the position of the point of intersection is specified using the point of the surface of the stone located on the segment joining:
the point of intersection between a ray and the simplified geometric shape; and
the point of reference in the stone.

Preferably, the position of the point is calculated using a map of the distances which includes, in a discrete set of directions around the reference point, the distance between the surface of the stone and the reference point.

These arrangements make it possible to improve the approximation made, while still retaining the calculation efficiency.

The present invention also relates to a computer program product comprising instructions for carrying out the steps of the procedure described above and to a data storage medium comprising such a computer program product.

### BRIEF DESCRIPTION OF THE DRAWINGS

In any case, the invention will be more clearly understood with the aid of the following description, with reference to the appended schematic drawing showing, by way of nonlimiting example, one embodiment of this procedure.

FIG. 1 is a flowchart showing the various steps of the procedure according to the invention.

FIG. 2 illustrates the step of determining the geometric center of a stone.

FIGS. 3 to 6 illustrate the various phases in the step of calculating the map of the normals.

FIGS. 7 to 18 illustrate the various phases in the step of calculating the multiple reflections.

FIGS. 19 and 20 illustrate an alternative way of calculating the multiple reflections, by refining the approximation by a map of the distances.

### DESCRIPTION OF THE PREFERRED EMBODIMENTS

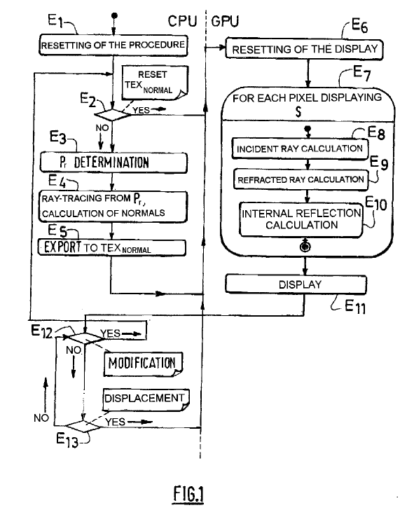

As shown in FIG. 1, a procedure for rendering images in real time of three-dimensional models of items of jewellery comprising at least one transparent or translucent stone having facets according to the invention comprises the following steps, which are carried out by computation means, in particular by a computer provided with a screen and having a central processing unit CPU and a graphics card provided with a graphics processing unit GPU.

The procedure is reset in a first step El. The user supplies a set of parameters relating to a stone to be displayed on the screen. In particular, it is necessary to supply:
a geometric definition GEOM of the stone S to be displayed;
the refractive index no of the external medium in which the stone S is placed;
the refractive index n, of the stone S;
the number of internal reflections nbRef in the stone S that have to be taken into account; and
the attenuation values αᵢ of the ith reflected ray.

Some of these parameters may be defined by default if the user does not supply them and/or may be downloaded from libraries. It should be noted that several values of the refractive index of the stone S may be given for several different wavelengths.

In a second step E2, a check is made as to whether the map of the normals is reset and updated with the geometric definition of the stone S.

If the answer is yes, the procedure passes directly to the sixth step E6 of resetting the display. Otherwise, the map of the normals TEX_{NORMAL} has to be calculated.

Thus, in a third step E3, a reference point Pᵣ in the stone S is determined.

This reference point Pᵣ is calculated for example as the intersection of planes of symmetry of the stone, of axes of symmetry of the stone, or, as the case may be, if the stone does not have sufficient planes or axes of symmetry, as the center of the largest cross section of the stone S, as shown in FIG. 2.

In a fourth step E4, the map of the normals TEX_{NORMAL} is calculated, which map will be stored in image or texture form. The objective of this step is to obtain an image representing the normals of the stone S used.

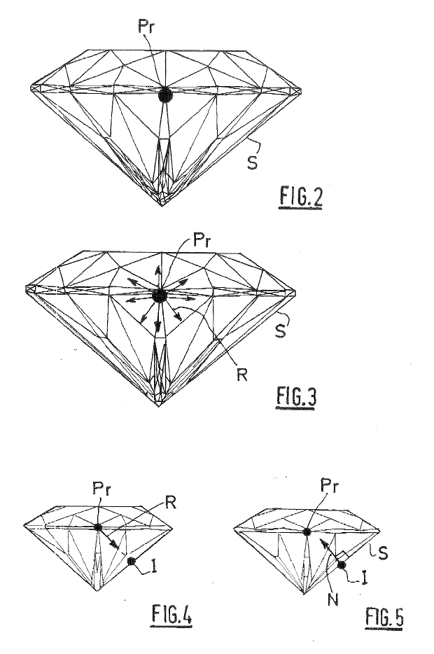

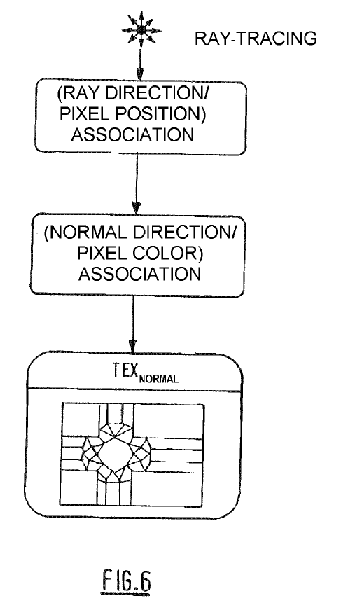

In a first phase, shown in FIG. 3, rays R are traced in a discrete set of directions in the space starting from the reference point Pᵣ.

In a second phase, for each ray R, the point of intersection I with the surface of the stone S is calculated, as shown in FIG. 4. The components Nxi, Nyi, Nzi of the normal N to the surface at this point are calculated.

In a third phase, the directions of normals N thus found in the second phase are stored in an image or a texture according to the direction of the ray traced in the first phase.

A pixel position on the image or the texture TEX_{NORMAL} is associated with each defined direction. The link between direction and position of the pixel is made in a manner known per se using the procedure for cubic environment maps. This procedure is not presented in detail here. This involves considering a closed surface of simplified geometry surrounding the reference point, especially a cube, and in transferring the various surfaces of this cube when opened flat, by “unfolding” this cube, to an image. It should be noted that it would be possible to use other procedures by using a relationship between a 3D direction and a 2D image that associates a single 2D point with each direction.

Associated with each defined direction is a pixel color, corresponding to the components of the normal in this direction. In particular, it is possible to convert the components of the normal into an RGB color according to a simple formula:

R=(Nx+1)×0.5;

G=(Ny+1)×0.5;

B=(Nz+1)×0.5.

The components of the normal are normalized so that the modulus of the normal is equal to 1.

Next, the color thus defined is transferred to the pixel corresponding to the direction of the ray. Thus, an image or a texture TEX_{NORMAL}, which may be exported in a fifth step E5, is obtained.

It should be noted that steps E1 to E5 are carried out on the central processor CPU, although the procedure used can also be adapted for the processor GPU of the graphics card. These steps are carried out only once after resetting the geometry.

Once the texture TEX_{NORMAL} has been exported, this may be communicated to the graphics processor GPU so that the latter performs the following steps. These steps therefore benefit from the strong parallel processing of the procedure.

In a sixth step E6, the graphics environment is reset by the graphics processor.

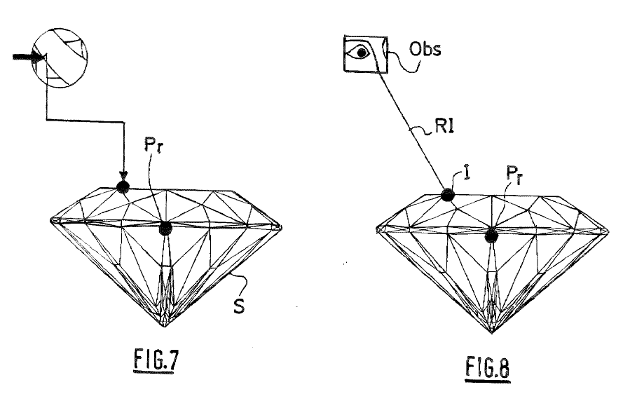

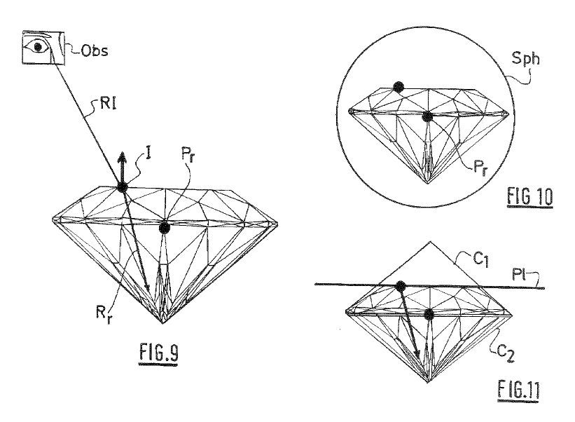

In a seventh step E7, a set of processing operations is carried out for each pixel of the rendered image displaying part of the stone, as shown in FIG. 7, this set of operations covering an eighth step E8, a ninth step E9 and a tenth step E10.

In the eighth step E8, a calculation is carried out on the incident ray. To do this, the precise geometry GEOM of the stone is used to determine the intersection I between:
an incident ray RI coming from the observation position Obs, in a direction corresponding to a given pixel; and
the surface of the stone S,

as shown in FIG. 8.

In the ninth step E9, a calculation is carried out on the refraction ray in the stone, using:
the refractive index n₀ of the external medium;
the refractive index n₁ of the stone, possibly differentiated for various wavelengths or ranges of wavelengths; and
the normal to the surface given by the graphics processor, it being possible for this normal to be obtained directly since in this step the precise geometry of the stone S is used.

These parameters are used in a calculation using Snell's law to calculate the refracted ray Rᵣ in the stone.

In a tenth step E10, the internal reflections in the stone are calculated. This calculation is in fact a simulation of the reflections of the light inside the stone, which does not use the actual geometry GEOM of the stone. Specifically, a simplified geometry of the stone is used, which encompasses the stone. Thus, as shown in FIGS. 10 and 11, it is possible in particular to choose a sphere or a double cone formed by two cones C1 and C2 opposed by the base, associated with a plane PI coinciding with the upper face of a stone S.

In the embodiment presented below, a sphere Sph is used.

To obtain a reflection effect close to reality, it is preferable for the sphere Sph, which is centered on the reference point Pᵣ, to have a slightly larger diameter than the largest dimension of the stone.

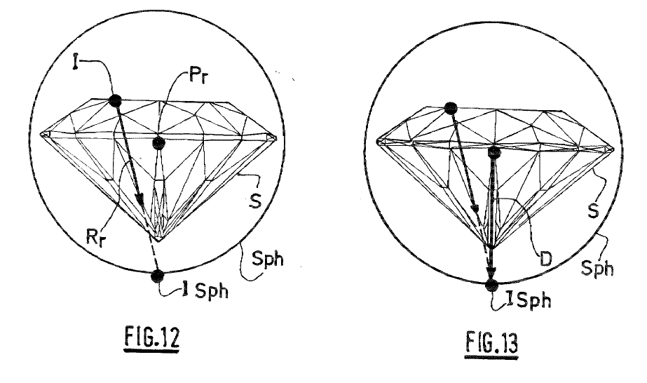

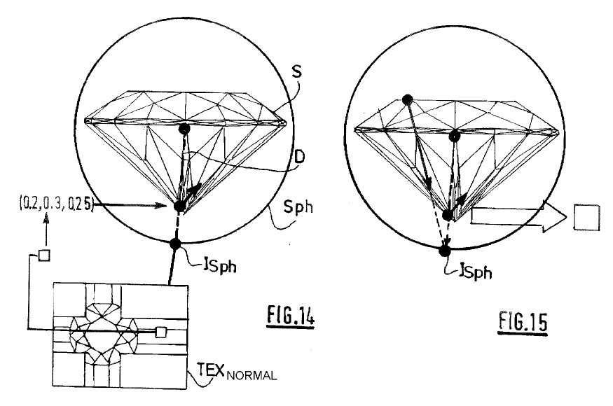

For each phase of the internal reflection calculation, the intersection of the ray with the sphere Sph is calculated. In particular, for the first internal reflection, the intersection I_{Sph} of the refracted ray Rᵣ with the sphere Sph is calculated, as shown in FIG. 12.

To calculate the reflection of the ray at the point of intersection I_{Sph}, the normals used are not those of the sphere but those of the map of normals calculated beforehand.

Thus, the direction D from the center Pᵣ of the stone to the point of intersection I_{Sph}, as shown in FIG. 13, is determined, followed by the corresponding point of the image of the normals as shown in FIG. 14.

The color of this point is converted into normal coordinates.

The coordinates correspond to the actual value of the normal N at the point Iₛ of the surface of the stone S located on the segment joining the point of intersection I_{Sph} on the sphere and the center Pᵣ of the stone.

Provided with values of the normal N and of the point I_{Sph}, we are able to calculate the contribution of the ray to the color of the pixel, taking into account the attenuation factor α₀.

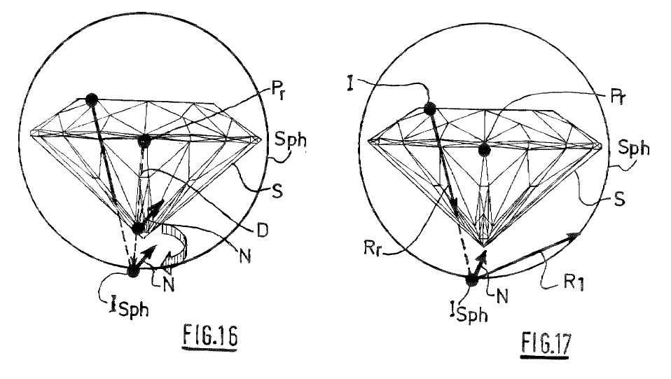

The normal N obtained is transferred to the point of intersection I_{Sph} on the sphere, as shown in FIG. 16.

As shown in FIG. 17, it is this normal that is used to reflect the ray Rᵣ according to Snell's laws.

Provided with this normal, we are able to calculate the reflection in the sphere and to continue the propagation of the refracted ray Rᵣ with the sphere Sph as a ray R1.

Next, the phases for calculating an internal reflection are repeated Nb_{Ref} times with the ray R1 and then with the following reflected rays R2 to RNb_{Ref}-1, as shown in FIG. 18.

It should be noted that the calculation of the intersection between a ray and a sphere is simple and can be carried out in real time. Each intersection provides its contribution to the color.

Once steps E8 to E10 have been carried out for each pixel of the rendered image displaying part of the stone, the set of processing operations forming step E7 is complete.

In an eleventh step E11, the graphics processor displays the rendered image obtained.

A twelfth step E12 checks whether a modification of the geometry of the stone has occurred. If the answer is YES, steps E2 to E11 of the procedure are again carried out.

Otherwise, a thirteenth step is carried out.

The thirteenth step checks whether a modification of the relative positioning between the observation position Obs and the stone has occurred. If the answer is YES, steps E6 to E12 of the procedure are again carried out by the graphics processor.

Otherwise, the twelfth step is carried out again.

A loop is thus formed between the twelfth and thirteenth steps if the geometry and the positioning of the stone remain the same.

It should be noted that the procedure is automated and adapts to each type of stone without intervention by an operator, but simply by providing the abovementioned parameters.

Given the quality of the rendition obtained, it is possible to use the same procedure in a non-real-time rendition by ray-tracing in order to reduce the computation time.

In an alternative way of implementing the procedure, the precision of the simulation of the multiple reflections may be increased by using as point of intersection from which the reflected ray R1 starts the point Iₛ of the surface of the stone S located on the segment joining the point of intersection I_{Sph} on the sphere to the center Pᵣ of the stone.

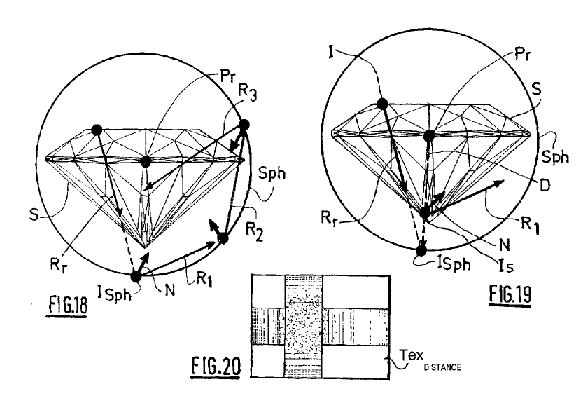

A more precise position of the point Iₛ may be obtained, as shown in FIG. 19, with a distance map TEX_{DISTANCE}, an example of which is shown in FIG. 20.

In this case, it is necessary to calculate, as is done for the map of the normals, in all directions from the reference point, the distance between the surface of the stone and the reference point. This calculation is performed only once for a given geometry.

Next, these distance values are stored in an image using a principle similar to that for the map of the normals except that the color no longer represents the direction but a distance.

It goes without saying that the invention is not limited to the single embodiment of this apparatus, described above by way of example, but on the contrary it encompasses all variants thereof.

1. A procedure for rendering images in real time of three-dimensional models of items of jewelry comprising at least one transparent or translucent stone having facets, which procedure comprises:
determining a reference point in the stone;
calculating components of normals to the facets of the stone in a discrete set of directions around the reference point and storing these components in a map of the normals; and
simulating light reflections within the stone:
by calculating an approximation of a point of intersection between a ray and the stone using a simplified geometric shape of the stone and
using, to calculate a direction of the reflected ray, a normal extracted from the map of the normals, corresponding to a point of the surface of the stone located in a direction of the point relative to the reference point.

2. The procedure as claimed in claim 1, in which the first intersection of a ray incident on the stone is calculated using the actual geometry.

3. The procedure as claimed claims 1, in which the simplified geometric shape is a sphere.

4. The procedure as claimed in claims 1, in which the simplified geometric shape comprises two cones opposed by a base.

5. The procedure as claimed in claim 4, in which the simplified geometric shape is bounded by an intersection of the two cones and of a half-space bounded by a plane coinciding with an upper face of a stone.

6. The procedure as claimed in claims 1, in which the map of the normals is stored in the form of an image, color information about a given pixel corresponding to the coordinates of the normal at a given point of a facet of the stone in a given direction.

7. The procedure as claimed in claims 1, in which the relative calculations at the intersections of a ray and the stone using a simplified geometric shape are carried out on a graphics processor.

8. The procedure as claimed in claims 1, in which the reference point is calculated as the intersection of planes of symmetry of the stone, of axes of symmetry of the stone, or as a center of the largest cross section of the stone.

9. The procedure as claimed in claims 1, in which a maximum number of reflections to be taken into account are used in the calculation steps.

10. The procedure as claimed in claim 9, in which different refractive indexes are taken into account for different wavelengths.

11. The procedure as claimed in claims 1, in which the approximation of the position of the point of intersection is specified using the point of the surface of the stone located on the segment joining:
the point of intersection between a ray and the simplified geometric shape; and
the point of reference in the stone.

12. The procedure as claimed in claim 11, in which the position of the point is calculated using a map of the distances which includes, in a discrete set of directions around the reference point, the distance between the surface of the stone and the reference point.

13. A computer program product comprising instructions for carrying out the steps of the procedure as claimed in claims 1.

14. A data storage medium comprising a computer program product as claimed in claim 13.
